(19) United States
(12) Patent Application Publication
(10) Pub. No.: US 2010/0132455 A1
(43) Pub. Date: Jun. 3, 2010

(54) Liquid Level Measuring Apparatus

(76) Inventor: Robert D. Boehmer, Cenetnnial, CO (US)

Correspondence Address: Robert D. Boehmer, 1695 W Sheri Lane, Littleton, CO, 53210, US

(21) Appl. No.: 12/606,655

(22) Filed: Oct. 27, 2009

Related U.S. Application Data
(60) Provisional application No. 61/108,933, filed on Oct. 28, 2008.

(51) Int. Cl. G01F 23/30

(52) U.S. Cl. 73/308; 73/311

(57) ABSTRACT

A liquid level measuring apparatus for measuring the level of a liquid in a bladder with flexible walls in which liquid in a container raises and lowers a plurality of floats, each float containing a magnetic element oriented in a vertical position. The floats are positioned within an inner guide tube. Pins of non-magnetic material restrict the vertical movement of the floats to sections of the inner guide tube with one float per section. The inner guide tube is placed inside the bladder. After placement of the inner guide tube, an outer sleeve is slid over the inner guide tube from the outside of the bladder with the bladder wall between the inner guide tube and outer sleeve. The outer sleeve contains magnetic reed switches that can be activated by the magnetic elements in the inner guide tube. Means of orientating the inner guide tube inside the bladder and assuring that the outer collar is at the correct position on inner guide tube such that the magnetic reed switches are activated by their associated float magnetic when the float magnetic is at the bottom of its section in the inner guide tube are provided. An electronic output device monitors the state of the magnetic reed switches to indicate the liquid level.

### REFERENCES SITED

U.S. Patent Documents

| | | |
|---|---|---|
| 3,419,695 | December 1968 | Dinkelkamp |
| 3,678,750 | July 1972 | DiNoia |
| 3,826,139 | July 1974 | Bachman |
| 4,056,979 | November 1977 | Bongort |
| 4,064,755 | December 1977 | Bongort |
| 4,609,796 | September 1986 | Bergsma |
| 4,804,944 | January 1989 | Golladay |
| 4,852,404 | August 1989 | Catanese |
| 4,976,146 | December 1990 | Senghaas |
| 5,026,954 | June 1991 | Cebulski |
| 5,224,379 | July 1993 | Koebernik |
| 5,347,864 | September 1994 | Senghaas |
| 5,627,523 | May 1997 | Besprozvanny |
| 6,067,854 | May 2000 | Yang |
| 6,067,855 | May 2000 | Brown |
| 6,408,692 B1 | June 2002 | Glahn |
| 6,452,202 | September 2002 | Eom |
| 6,481,278 B1 | November 2002 | Kaylor |
| 6,563,306 B2 | May 2003 | Sato |
| 6,571,626 B1 | June 2003 | Herford |
| 7,231,821 B2 | June 2007 | Fling |
| 7,377,162 B2 | May 2008 | Lazaris |

### OTHER PUBLICATIONS

The CamelBak Products, LLC web site http://www.camelbak.com; U.S. Pat. 7,063,243 B2 (Forsman, June 2006) assigned to CamelBak Products, LLC, Petaluma, Calif. (US) and Coto Technology Technical & Applications Information [Switches] p 142.

### RELATED APPLICATIONS

This application is a continuation of U.S. provisional patent application 61/108,933, entitled “Liquid Level Measuring Apparatus” which was filed on Oct. 28, 2008 with claims 1-9 of this application the same as claims 1-9 of the referenced provisional application.

### FIELD OF THE INVENTION

This invention relates to a liquid level measuring apparatus, in particular liquid level measuring apparatus of the type having a vertical guide tube having a plurality of permanent magnets encapsulated in buoyant capsules, a plurality of magnetic reed switches enclosed in a sleeve partially surrounding the tube and a means to indicate approximate liquid levels in a non-rigid plastic bladder.

### BACKGROUND OF THE INVENTION

The measurement of the level of a liquid in a container by use of one or a plurality of reed switches that are activated by one or a plurality of permanent magnets is well known as disclosed in U.S. Patents. The following U.S. patents are representative of such disclosures:
U.S. Pat. No. 3,419,695
U.S. Pat. No. 3,678,750
U.S. Pat. No. 3,826,139
U.S. Pat. No. 4,056,979
U.S. Pat. No. 4,064,755

These devices typically use a toroidal shaped permanent magnet that is enclosed within a buoyant capsule that floats on the surface of the liquid. The reed switches are held in a cylindrical tube. The capsule is place over the tube such that the tube is within and perpendicular to the capsule hole such that the two are co-axially aligned with each other. Sufficient clearance between the tube and the capsule allows the capsule to move up and down the tube with changes in the level of the liquid. When the capsule reaches the level of a reed switch, the switch is activated, providing a means for indicating the level of the liquid, such as closing an electrical circuit,

The precession of the level measurement can be increased by increasing the number of reed switches. Thus, apparatus such as described in U.S. Pat. Nos. 5,374,846 and 6,571,626 B1 may incorporate as many as 1040 sensors.

Other devices, similar to the above referenced, may use other magnetic sensing elements rather than reed switches. The use of Hall Effect devices is described in U.S. Pat. Nos. 6,481,278 B1 and 6,563,306 B2.

While these patents address many of the requirements of measuring the liquid level in a container, they do not address the particular requirements addressed by the present apparatus. Many sports and recreation enthusiasts such as bicyclists, hikers and joggers are concerned with dehydration. This is indicated by the number of backpacks that are available that contain a plastic bag or bladder or reservoir meant to contain a drink liquid referred to as hydration systems. As suggested by the name, the backpack is carried on the individual's back with straps that go over the shoulders. The backpack may be large enough to contain items other than the bladder such as those a hiker may carry or only large enough to carry the bladder. A flexible plastic tube goes from the bladder over the individual's shoulder with a mouth piece or nozzle at the other end. Thus the individual can drink from the bladder without removing it from the backpack. One advantage these hydration systems offer over say water bottles is that they provide hands free access to the hydration liquid and do not cause the user to loss concentration or vision while drinking. However, a disadvantage to these hydration systems is that with the liquid container being carried on the back, the individual user typically is not able to monitor the amount or level of liquid in the bladder. Once the bladder is filled with liquid, they are seal usually with a screw on cap to prevent the liquid from spilling outside or otherwise being squeezed out. In addition, since the bladders are reused multiple times and are not considered disposable, they must be easily washed. Also, a liquid level measuring device must not require making modifications to the bladder such as making holes in the bladder for lead wires.

Other technologies such as commercially available charge-transfer sensor integrated circuits are used for measuring liquid levels in a container. These devices work by monitoring the change of capacitance between electrodes placed on the outside of non-conductive containers. Typically, one or more active electrically conductive electrodes such as aluminum or copper foil are attached to one side of the container and a ground or common electrically conductive electrode on the opposite side. While such a system would work for our application, it has disadvantages. With the bladder filled with an aqueous solution, the dielectric constant of the material between an active electrode and the common electrode is high (78 for water) while the distance between them is relatively large. As liquid leaves the bladder the dielectric constant drops to approximately 2-3 (for plastics). Also, the distance between the electrodes also decreases. Referring to the equation used to calculate the capacitance of a parallel plate capacitor, Eq. 1, we see that a decrease in dielectric constant results in a decrease in capacitance while a decrease in distance between the parallel plates increases the capacitance. Thus, the changes have opposite effects on the capacitance. If the changes were the same (for example, if κ decreased buy a factor 30 and d decreased by a factor of 30) there would be no net change in capacitance. Such technologies are more suited for fixed wall containers.

C=κε_{0A/d} Eq. 1

Where C is the capacitance in farads, κ is the dielectric constant of the material between the parallel plates, ε₀ is the permittivity constant, A the area of the plates, and d the distance between the plates.

Another disadvantage of this method is that it requires the electrode to be solidly attached to the bladder and be able to withstand washing coming off or the foil cracking and loosing electrical conductivity. In general, this technology is better suited for rigid containers where the only change occurs in the permittivity of media between electrodes and the distance between electrodes remains constant.

### SUMMARY OF THE INVENTION

The present apparatus meets these needs. The tube with magnetic floats is easily placed inside the bladder through the filler hole and is likewise easily removed for washing and cleaning. Furthermore, no leads or electrical wiring must go from the inside of the bladder to the outside. Nor is there any electrical circuitry inside the bladder. No modification of the bladder is required. Finally, the apparatus, not requiring a multitude of components nor costly components, is of low cost to manufacture.

The liquid level measuring device according to the description herein comprises a plurality of magnet float capsules and an equal number of magnetic reed switches. The magnet float capsules are contained in a semi-rigid plastic tube that fits vertically within the plastic non-rigid bladder containing the fluid. Both ends of the tube are open so that the lumen of the tube is contiguous with the inside of the bladder so that the liquid level in the tube is equal to the liquid level in the bladder. The tube is separated into sections using plastic pins with each section containing a magnet float. The pins restrict the movement of the magnet floats to their respective sections while allowing the free flow of the liquid into and out of the tube. The length of the pins with the exception of one of the end pins is equal to the outer diameter of the tube so that the ends of the pins are flush with the outer wall of the tube.

The magnetic reed switches are contained in a sleeve approximately the same length of the tube with inner diameter somewhat larger than the outside diameter of the tube. A slit in the sleeve somewhat wider than the thickness of the bladder when it is empty of liquid runs its entire length. The tube is placed against the wall of the bladder such that the wall of the bladder substantially encloses the tube longitudinally. The sleeve is positioned on the outside of the bladder along the tube such that the sleeve and the tube align co-axially with each other with the wall of the bladder separating the two effectively clamping the tube in place. This is accomplished by sliding the sleeve along the tube until the reed switches are at the same level as the magnet floats when the magnet floats are at the bottom of their respective section. To ensure that the magnet reed switches align with the magnet floats, a stop on one end of the tube is included so the sleeve can be slide up to said stop but not past it. This stop could be accomplished by making the outer diameter of the tube at one end larger than the inner diameter of the sleeve. A preferred way which will be made obvious is to increase the length of the pin used to restrict the movement of a magnet float at one end of the tube such that one end of the pin protrudes slightly from outer wall of the tube with the other end of the pin remaining flush with the outer wall of the tube. The slit at one end of the sleeve is made wider to accommodate the protruding end of the pin. This method ensures both the proper alignment of the magnet floats with the magnetic reed switches and the radial orientation of the tube.

Once the sleeve is positioned in such a manner, the bladder can be filled with liquid and the filling orifice closed. With the bladder filled with liquid, the magnet floats are at the topmost travel in their respective sections as set by the plastic pin and are sufficiently distanced from the associated magnetic reed switch as to not affect the state of the magnetic reed switch. As the level of the liquid in the bladder drops, first the top most magnet float drops until it reaches the lower most travel of its section determined by the position of the plastic pin. At this point, the magnet in the float is juxtaposed with its respective magnetic reed switch, activating the switch. As the level of the liquid in the bladder continues to drop, the next highest magnet float drops until it too reaches the bottom most travel of its section, activating its associated magnetic reed switch. This continues until the lowest magnet float reaches the bottom most travel of its section, activating its magnetic reed switch. The state of the magnetic reed switches is monitored by an electronic circuit. Such a circuit, for example, would light a LED associated with the lowest activated magnetic reed switch and an audio alarm would sound when the lowest magnetic reed switch closes.

As the level of the liquid in the bladder drops, the bladder above the liquid level collapses. At some point, collapsed bladder closes off the top of the tube. At this point, the level of the liquid in the tube will no longer fall even when the level of the liquid in the bladder falls. In effect, a vacuum in the top of the tube is formed. To prevent this from occurring, vent holes are made at specific distances along the tube. These holes must face into the bladder volume to be effective. If, for example, they were oriented against the wall of the bladder, they would be blocked off and would not act as a vent. Having these holes aligned with the protruding pin, when the apparatus is assembled as described above, the vent holes are automatically oriented toward the bladder volume.

### BRIEF DESCRIPTION OF THE DRAWINGS

FIG. 1 is a front view of an embodiment of the present invention mounted on a liquid containing bladder;

FIG. 2 is a cross section view in the horizontal top plane showing the relation between the inner guide tube, flexible bladder wall, and outer sleeve of FIG. 1;

FIG. 3 is a cross section view in the vertical or frontal plane showing the relation of the major components particularly that of the magnetic reed switches and magnet floats and the inner guide tube and outer sleeve of FIG. 1;

FIG. 4 is a view of the outer guide sleeve of FIG. 1;

FIG. 5 is a cross section view in the vertical or front plane of the inner guide tube showing the magnet floats and pins of FIG. 1;

FIG. 6 is a cross section view in the vertical or frontal plane of the outer sleeve showing the imbedded magnetic reed switches of FIG. 1;

FIG. 7 shows an implementation of the output device.

### DESCRIPTION OF THE PREFERRED EMBODIMENTS

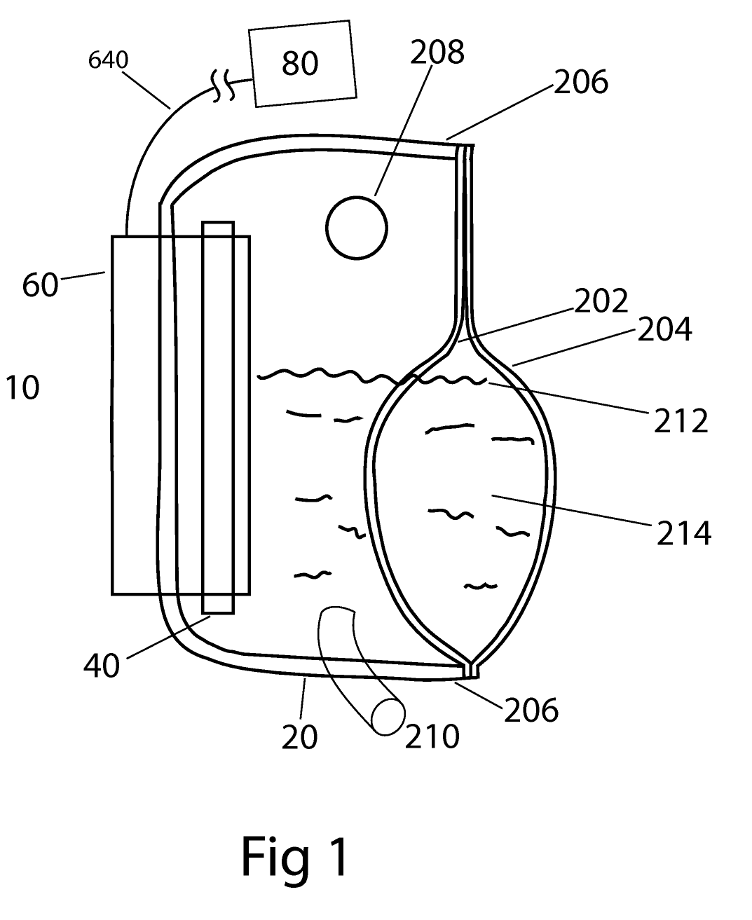

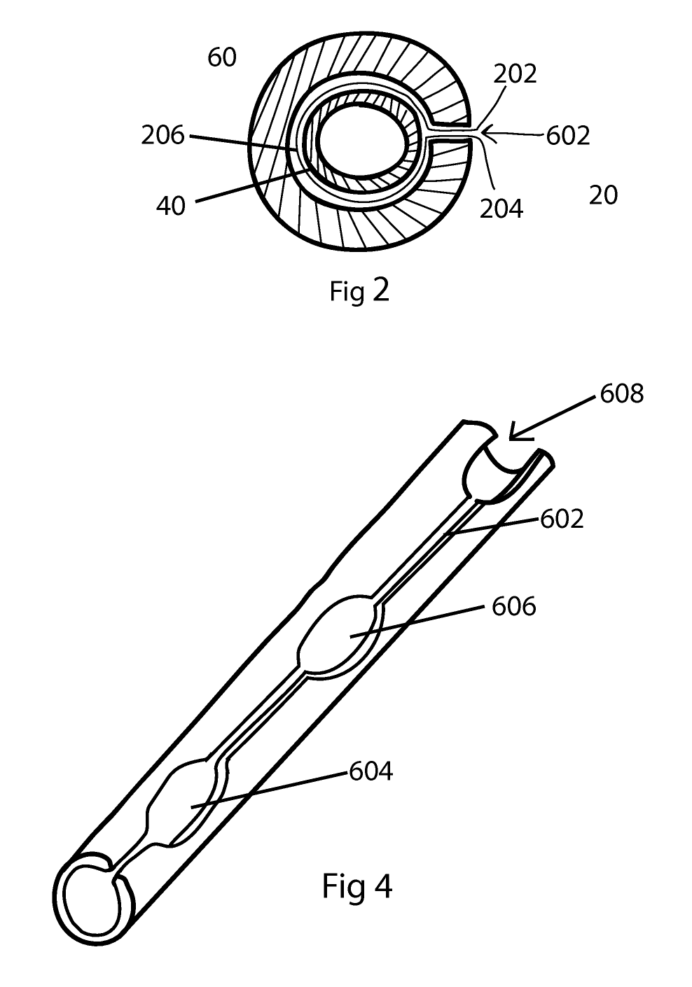

Referring to the drawings, and in particular FIG. 1, the reference numeral 10 generally indicates the liquid level measuring apparatus of the present invention consisting of inner guide tube 40, outer sleeve 60 and level indicator output device 80 attached to a flexible plastic bag 20, herein after referred to as bladder consisting of two layers, a front layer 202 and a back layer 204 of thin flexible plastic material such as a polyurethane with said layers 202 and 204 sealed together along their entire outer edges by some method such as RF welding to form outer seam 206. Filler hole 208 is used to add liquid to bladder 20 and, after filling, is sealed with a screw-on cap and drink tube 210 at the bottom of bladder 20 allows the user to suck the liquid from bladder 20 partially filled with liquid 214. The level of the liquid in bladder 20 is indicated by 212. Such bladder 20 is typically carried in a backpack used by hikers and bikers. The liquid level measuring apparatus 10 is attached to bladder 20 along one edge of bladder 20 with inner guide tube 40 inside bladder 20 and outer sleeve 60 outside of bladder 20. FIG. 2 shows this arrangement of bladder 20, inner guide tube 40 and outer sleeve 60 with bladder 20 front layer 202 and back layer 204 and seam 206 longitudinally around inner guide tube 40 with outside sleeve 60 around the outside in a cross sectional view.

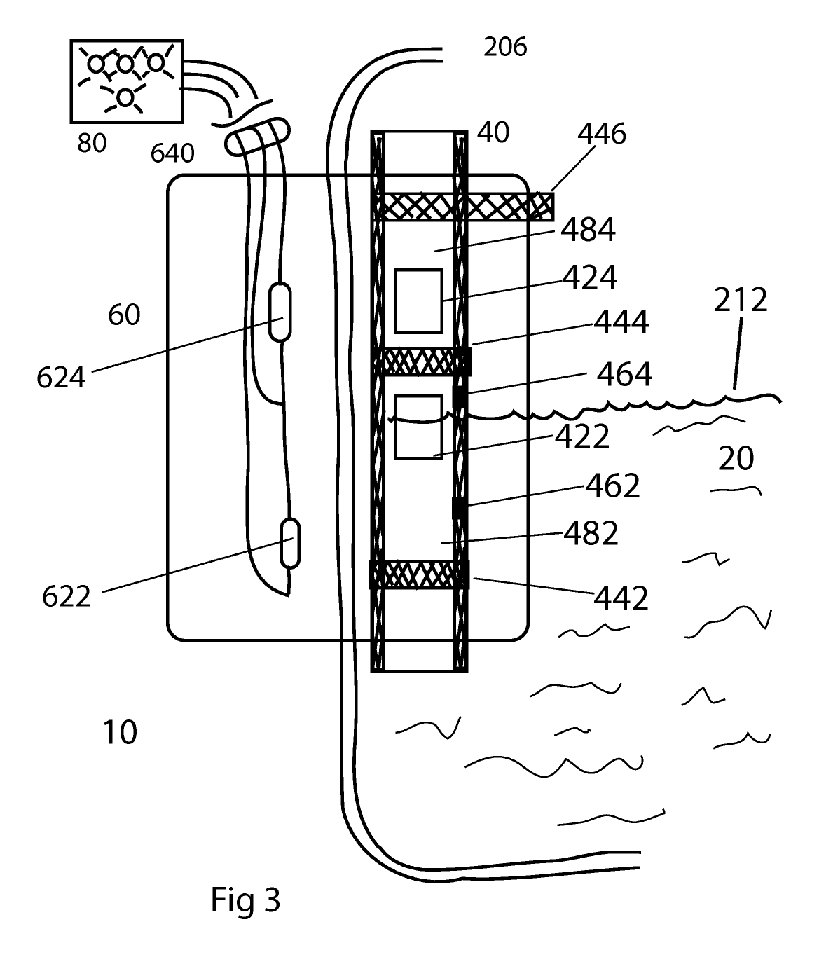

A more detailed sketch of the present apparatus is depicted in FIG. 3. The liquid level measuring apparatus includes an inner guide tube 40 made of a non-magnetic material such as polypropylene that contains a plurality of magnet floats, in this case and for a clearer understanding two floats 422 and 424 are described, each float containing a permanent magnet and outer sleeve 60 also made of a non-magnetic material such as but not limited to polypropylene or ABS containing an equal number of magnetic reed switches as there are magnet floats, in this case two magnetic reed switches 622 and 624. It is understood that more float/switch combinations can be used for measurement of more liquid levels with the constraint that the magnetic floats must move sufficiently away from the reed switches such that the reed switches will be deactivated. Inner guide tube 40 is placed inside bladder 20 in a vertical orientation. Outer sleeve 60 has a longitudinal slit 602 in FIG. 4 running its full length somewhat wider than the thickness of bladder 20 when empty that is slightly wider than the thickness of bladder 20 front layer 202 and back layer 204. Liquid level measuring apparatus 10 is set up or installed on bladder 20 by first placing inner guide tube 40 inside bladder 20 through filler hole 208 while bladder 20 is empty. Inner guide tube 40 is then held against bladder 20 wall such that bladder 20 wall substantially encircles inner guide tube 40 preferably where front layer 202 and back layer 204 are sealed together at seam 206. From the outside, outside sleeve 60 is slid onto bladder 20 and inner guide tube 40, with bladder 20 layers 202 and 204 in slit 602 of sleeve 60. Electrical conductors 640 in FIG. 7 connect magnetic reed switches 622 and 624 to electronic circuitry that monitors the state of magnetic reed switches 622 and 624 and indicates the level of liquid in bladder by activating output components such as LEDs, a LCD, and/or audio buzzers.

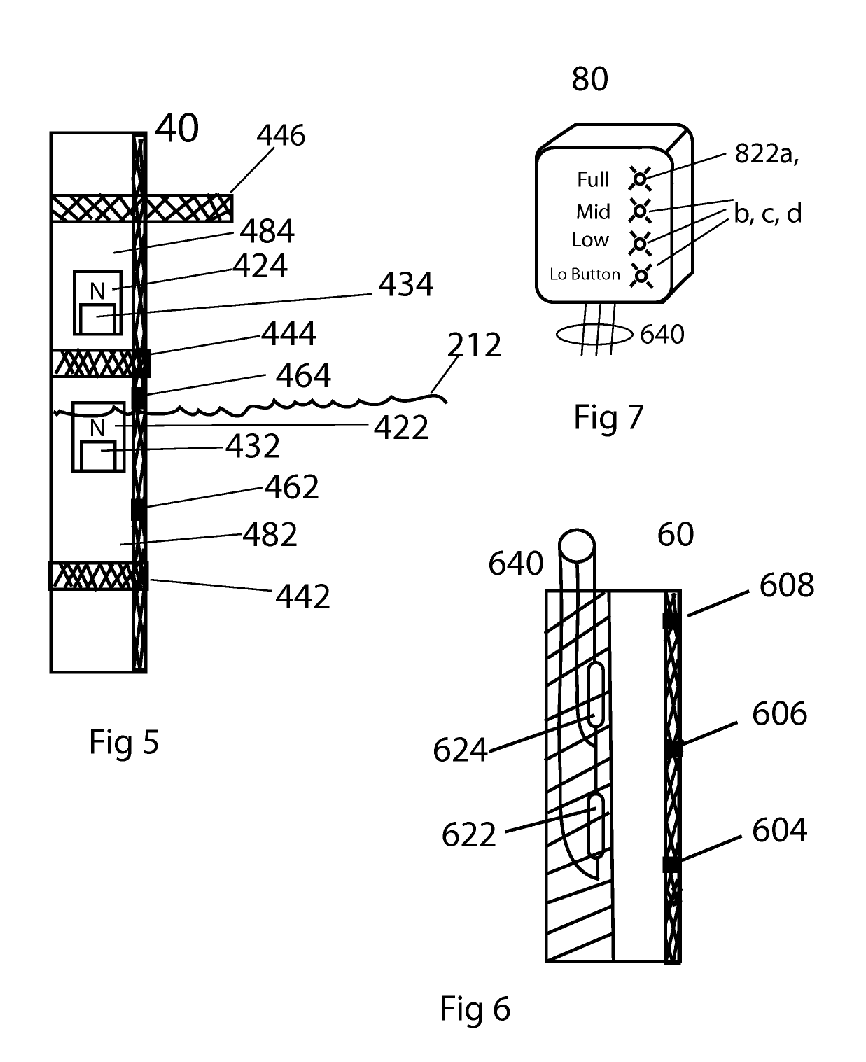

FIG. 5 shows inner guide tube 40 in more detail. Inner guide tube 40 contains magnet floats 422 and 424 that can freely move longitudinally up and down within inner guide tube 40 and pins 442, 444 and 446 that restrict the up-down movement of magnet floats 422 and 424. Magnet floats 422 and 424 contain permanent magnets 432 and 434 that are located at the bottom of the floats. The remaining volume of the magnet floats 422 and 424 is filled with atmospheric air that give the floats sufficient buoyancy so the top of the float is slightly above or at the level of the liquid 212. Pins 442, 444 and 446 separate inner guide tube 40 into two sections 482 and 484, each section containing a magnet float. The diameter of pins 442, 444 and 446 is sufficiently small to allow the free flow of liquid into and out of inner guide tube 40 but sufficiently large to restrict the movement of magnet floats 422 and 424. With the exception of top pin 446, the length of the pins is equal to the outer diameter of inner guide tube 40. In this embodiment, the topmost pin, pin 446, is somewhat longer than the other pins so that it protrudes from inner guide tube 40 into the body of bladder 20 and is in line with vent holes 462 and 464. The protruding end of this pin is used to align inner guide tube so vent holes 462 and 464 are oriented into bladder 20 rather than against layer 202 or 204. Of course, lengthening bottom pin 442 and making the length of top pin 464 equal to the outer diameter of inner guide tube 40 would be equally effective. Both ends of inner guide tube 40 are open to allow the liquid in the bag to also fill inner guide tube 40. As liquid level 212 in bladder 20 drops from full, top float 424 drops until it reaches pin 444 and stops. At this point, magnet float 424 is aligned with magnetic reed switch 624 and activates the switch. As liquid level 212 continues to drop, float 422 begins to drop until it reaches pin 442 and stops. At this point, magnet float is aligned with magnetic reed switch 622 and activates the switch. Now both magnetic reed switches 622 and 624 are activated. Vent holes 462 and 464 are to insure that a partial vacuum does not form in inner guide tube 40 as liquid level 212 drops. When liquid level 212 drops, the empty portion of bladder 20 causes front layer 202 and back layer 204 to close on each other as depicted in FIG. 1 and at some level effectively closing the top of inner guide tube 40. As the liquid level in bladder continues to fall, a partial vacuum above the liquid in the tube could forms and the liquid in inner guide tube 40 would no longer drop. Two vent holes 462 and 464 in inner guide tube 40 are made to allow venting of inner guide tube 40 and thus preventing a partial vacuum from forming above the liquid in inner guide tube 40 allowing the level of liquid in inner guide tube 40 to maintain the same level as liquid level 212 in bladder 20. All component parts of inner guide tube 40 are made of a non-magnetic material such as polypropylene that meets FDA requirements for Title 21, Chapter 1, Part 177 for use as basic components of repeated food contact surfaces.

Outer sleeve 60 as depicted in FIG. 4 and in more detail in FIG. 6 is approximately equal in length to inner guide tube 40. The inner diameter of outer sleeve 60 is approximately equal to the outer diameter of inner guide tube 40 and the thickness of bladder 20 when emptied of liquid with sufficient clearance to allow outer sleeve 60 to be slid around inner guide tube 40 with inner guide tube 40 on the inside of bladder 20 and outer sleeve 60 on the outside of bladder 20 thus bladder layers 202 and 204 and seam 206 are between outer sleeve 60 and inner guide tube 40. Slit 602 runs the full length of sleeve but broadens at 604 and 606 and at one end 608 of outer sleeve 60. The width of slit 602 is slightly greater than the width of bladder 20 when empty to allow for clearance of bladder 20 layers 202 and 204 when sleeve 60 is attached to bladder 20. Magnetic reed switches 622 and 624 are located on the opposite side of slit 602. Magnetic reed switches 622 and 624 are molded into outer sleeve 60 with electrical conductors 640 exiting outer sleeve 60 at the top. Electrical conductors 640 are electrically attached to magnetic reed switches 622 and 624 such that the state of magnetic reed switches 622 and 624 can be determined by monitoring the voltage across the individual switches. Thus, using pull up resistors attached to a voltage source such as one or more batteries in output device 80 and connected to lead of each of magnetic reed switches 622 and 624 with the second lead of each magnetic reed switch 622 and 624 connected to common, when a switch is in the open state, the voltage at the lead of the switch will be equal to the supply voltage. When the switch is in the closed state, the voltage on the active lead will be pulled down to zero volts or common. The sleeve was molded using a polyurethane material, 7.125 inches long with inner diameter of 0.45 inches and outer diameter of 0.70 inches. Slit 602 had width of 0.08 inches and broadened regions 604 and 606 were 0.30 inches and broadened end 608 was 0.20 inches. The inner diameter of sleeve resulted in a snug fit of sleeve over inner guide tube and bladder (FIG. 2) but yet easy to slide sleeve into position. Another embodiment which may be preferable in certain applications and particularly applicable to longer models is to increase the width of broadened region 606 such that the sleeve could slightly flex.

The alignment of outer sleeve 60 with inner guide tube 40 is critical as is the orientation of inner guide tube 40 in bladder 20. First, inner guide tube 40 must be oriented in bladder 20 such that vent holes 462 and 464 are directed into bladder 20 proper rather than against either layer 202 or 204 of bladder 20. This is accomplished increasing the length of one of the end pins 442 or 446 such that it protrudes past the outer wall of inner guide tube 40, FIG. 3 showing the top pin 446 as the protruding pin, and that the protruding end of the pin be in alignment with vent holes 462 and 464 in inner guide tube 40. With widened slit 608 on the same end of outer sleeve 60 as protruding pin 446 on inner guide tube 40, when outer sleeve 60 is slid onto bladder 20 and inner guide tube 40, protruding pin 446 will slide into widened end slit 608 and inner guide tube will be oriented correctly in bladder 20. Protruding pin 446 also acts as a stop for aligning outer sleeve with inner guide tube 40. By sliding outer sleeve 60 onto bladder 20 and inner guide tube 40 until protruding pin 446 reaches the end of widened slit 608 the magnet sections 482 and 484 will be aligned with magnetic reed switches 622 and 624 when magnet floats 422 and 424 are at the bottom of their respective sections and will be in correct proximity to activate magnetic reed switches.

Floats 422 and 424 in FIG. 5 may be constructed of any suitable non-magnetic material but when used in a liquid meant for drinking, the material must meet certain FDA requirements such as those defined in Title 21, Chapter 1, Part 177 “use as basic components of repeated food contact surfaces.” The float should be hermetically sealed. The float must be sufficiently light to maintain buoyancy such that with magnet 432 and 434 placed at the bottom of the float, the top of the float will be slightly above the level of the liquid. The float is elongated or capsule shaped with outer diameter sufficiently less than the inner diameter of inner guide tube 40 as to allow unhindered vertical movement within the float's restricted section of vertical movement and minimize surface tension between the float and the inner wall of the inner guide tube 40. The float must also be of sufficient length so as to maintain vertical alignment within the inner guide tube. The magnets may be of bar or cylindrical shape and are fixed at one end of the float either through the molding process, use of adhesive, or mechanical fit such that the magnet field is parallel to the longitudinal axis of the float with either N pointing to the more distant end of the float or S pointing to the more distant end of the float. Alignment of magnets 432 and 434 with respect to the magnetic reed switches is of critical importance for consistency of switch operation. The preferred alignment of magnets 432 and 434 is with their N and S poles oriented parallel to the switch as shown in FIG. 3 thus the importance of the floats maintaining vertical alignment within the inner guide tube as shown in FIG. 5. This orientation provides for the highest reliability and minimizes the affect of switch sensitivity. If either of the poles of the magnet were pointed directly at the magnetic reed switch an “off” zone exists when the magnet is positioned at the center of the switch and the switch would become deactivated. Although this arrangement would work by not allowing the magnet to reach the center of the switch, this could still create reliability and repeatability problems. Another problem with this orientation of the magnets is if a float would to rotate on its longitudinal axis. If this rotation were less than 180°, neither pole of the magnet would be pointing at the switch and the magnet may or may not activate the switch depending on the angle of rotation and sensitivity of the switch. Switch sensitivity (as defined by the amount of magnetic force required to activate the switch) can vary be a factor of 2 or 3 within the same switch model further complicating the issue of reliability. The worst condition is if the float rotated 90°, in which case the magnet would most likely not activate the switch.

Three conductor cable 640 connects magnet reed switches 622 and 624 to output device 80. Removable clips can be used to secure cable 640 to drink tube 210. In some hydration systems, drink tube exits the backpack through a small hole. Taking this into consideration, an electrical connector preferably with a locking mechanism connects and disconnects cable 640 to output device is necessary. Level indicator output device, FIG. 7 contains battery powered electronic logic circuitry such as a microcontroller for monitoring the state of magnetic reed switches 622 and 624, battery condition circuitry and output components such as LEDs 822a-c indicating the liquid level height of Full, Mid, or Low, a buzzer to indicate that a change in level has occurred such as from Full to Mid or Mid to Low. The buzzer can also act as a warning when to liquid drops to the Low level, and LED 822d to indicate low battery voltage.

What is claimed is:

1. A liquid level measuring apparatus comprising in combination:
an inner guide tube for vertical positioning in the liquid whose level is to be measured;
one or more elongated magnet floats within the inner guide tube with outer diameter sufficiently small to allow for the free longitudinal movement to rise and fall with the liquid level;
each float containing a permanent magnet;
an outer sleeve for vertical positioning outside a flexible liquid container with sufficient inner diameter to fit on inner guide tube with liquid container wall between inner guide tube and outer sleeve;
an outer sleeve containing an equal number of magnetic reed switches as there are magnet floats aligned substantially parallel to the axis of said outer sleeve;
means to monitor the state of the magnetic reed switches;
means to indicate the state of the magnetic reed switches.

2. The invention defined in claim 1 in that said inner guide tube is separated into sections with each section containing a magnet float.

3. The invention defined in claim 1 in that said magnetic reed switches are closed when their associated magnet float reaches the bottom of its section of movement.

4. The invention defined in claim 1 in that said inner guide tube contains vent holes along its longitudinal axis to allow flow of fluid out of inner guide tube, preventing a drop in pressure in the top portion of inner guide tube above the liquid level in the bladder.

5. The invention defined in claim 4 with a protruding pin at either the top or bottom of the inner guide tube to align the vent holes such that they face into the bladder.

6. The invention defined by claim 5 with said protruding tube acting as a stop when placing the outer sleeve into position such that the magnetic reed switches align with their respective magnet floats when the magnet floats are at the bottom of their section of movement.

7. The invention defined in claim 1 with means to monitor the state of each magnetic reed switch whether the switch is open or closed.

8. The invention defined in claim 7 with means to indicate the liquid level such as the use of LEDs, buzzers or an LCD display.

9. The invention defined in claim 1 with varying number of floats, associated sections in inner guide tube and associated magnetic reed switches.
